(19) United States
(12) Patent Application Publication
(10) Pub. No.: US 2019/0104716 A1
(43) Pub. Date: Apr. 11, 2019

(54) Pest Guard For Marine Mooring Lines

(71) Applicant: Erik Thomas Erton, Pompano Beach, FL (US)

(72) Inventor: Erik Thomas Erton, Pompano Beach, FL (US)

(21) Appl. No.: 15/727,610

(22) Filed: Oct. 8, 2017

(51) Int. Cl. A01M 1/14; A01M 1/10; A01M 23/00; B63B 21/00

(52) U.S. Cl. CPC A01M 1/14; B63B 21/00; A01M 23/005; A01M 1/103

(57) ABSTRACT

A pest guard for the blockage of pests along dock lines and ship hawsers in order to prevent pests from reaching boats and pleasure craft moored by these lines. Such pests include but are not limited to: rodents, iguanas, raccoons, opossums, and crawling insects such as ants, spiders and cockroaches. Comprised of a conical shaped main body with a flat bottom, a center shaft extends from the middle of the main body. This shaft shall be hollow as to allow the passage of dock line. The bottom of the interior of this conical shape allows for the placement of insect prohibiting adhesive substance that may be in the form of flat disks, which are replaceable.

### FIELD OF INVENTION

This invention serves to provide a form of pest control barrier in a marine environment. Specifically, this invention aims to decrease the need for pest removal or extermination for various forms of pests. This prevention is accomplished by the use of a conically shaped device placed on mooring lines to inhibit crawling pests from accessing boats by crawling along dock lines.

### PRIOR ART AND GENERAL BACKGROUND

Prior art has long recognized the need for shields to prevent rodents and insects from attaining access to ships docked at shore. These pests can cause much financial damage; they may destroy cargo, eat upholstery and chew through electrical connections. They may also transmit and transport illnesses on board ships, placing unnecessary hardships on crew, and causing illnesses or even death.

It is a common occurrence for vermin to infest marine vessels as they search for food, water, and nesting sites in the closed spaces and holds of such vessels. Once the vessel is infested, sanitation issues arise and damage to electrical circuits can cause equipment failures, fires and explosions aboard vessels.

These animals are difficult to capture, trap or kill because they are often hidden in very small crevices and openings of the vessels, resulting in the need for fumigation, after which, the removal of dead animals can be difficult or impossible. This results in dead and decaying animals in hidden spaces of the boat, which may attract more pests and cause more disease.

From time to time, any vessel will be docked in a situation in which a mooring line connects the vessel to the shore and/or anchor is placed on shore, thereby creating a walkway for vermin and other pests. Even using whips and other devices to keep a vessel further from the dock will not prevent these animals from crawling along the lines.

Typical prior art solutions address only one specific type of pest such as rodents alone or crawling insects alone. Usually, these solutions use a disk or a series of multiple disks attached to a rope to inhibit access to the vessel. People have been searching for pest prevention systems for hundreds of years. However, prior solutions are insufficient to prevent some animals from hoping over the disk or insects from crawling through the space between the line and the disk. Many prior solutions include the use of split disks, which are clamped onto mooring lines with the disks secured in place. However, none of these designs use a moving vermin guard in conjunction with a physical barrier against insect penetration. Therefore, this current invention is unique because it aims to combine many elements of pest prevention to create a product which is ideal for small boats and pleasure craft, by combining a rotating funnel shaped physical barrier, which makes it difficult for animals to jump across or crawl over with a glue trap barrier to impede the progress of insects along the lines.

### SUMMARY OF THE INVENTION

The proposed invention is a device to impede the passage of pests along lines which connect from the shore to vessels, particularly in the small ship and pleasure craft markets, where the device must be relatively compact and lightweight, as well as cost effective. It is also the intention of this invention to provide easy to understand installation methods, without damaging the mooring lines. A conical shaped pest shield of sufficient diameter to prevent the passage of vermin and insects crawling along marine moorings is coupled with an adhesive disk interior to trap insects. This conical device will rotate freely, causing larger animals which try to crawl over the device to lose their footing and be thrown into the water. The present invention includes the conical shaped body, which has a center axis perpendicular to a rigid tube which can be slid on to mooring lines. There is also an aperture which is appropriately sized to fit mooring lines. This marine pest shield also includes a glue trap which is coated in an adhesive substance which can be affixed to the inside surface of the conical structure and replaced from time to time as necessary.

The above description will become more understandable upon consideration of the following diagram and descriptions of the present invention.

### BRIEF DESCRIPTION OF DRAWINGS

FIG. 1 Shows an overhead view of the pest guard positioned on a mooring line, and a section cut overhead view of the pest guard positioned on a mooring line. The section cut view displays the device as if it was cut straight down the middle while on the dock line.

FIG. 2 Gives a rear view of the pest guard when attached to a mooring line. This end is the closed side of the device that is to face the marine vessel. The only opening on this end is the section just large enough to allow a mooring line to pass through.

FIG. 3 Shows the front view of the pest guard while attached to the mooring line. This end is the open faced section which faces the shore. This view displays the sticky glue trap, which is located in the interior of the conical device.

FIG. 4 Displays an angled up overhead view of the device. The stabilizing rod is seen protruding from the center of the device, allowing the guard to provide protection at all angles of the mooring line, particularly slack line.

FIG. 5 Shows an angled down version of the device. A tightening collar (shown in grey) may be used to secure the guard in place. As an alternative, a knot in the mooring line may also be used to prevent the pest protector device from sliding back and forth along the longitudinal axis of the mooring line.

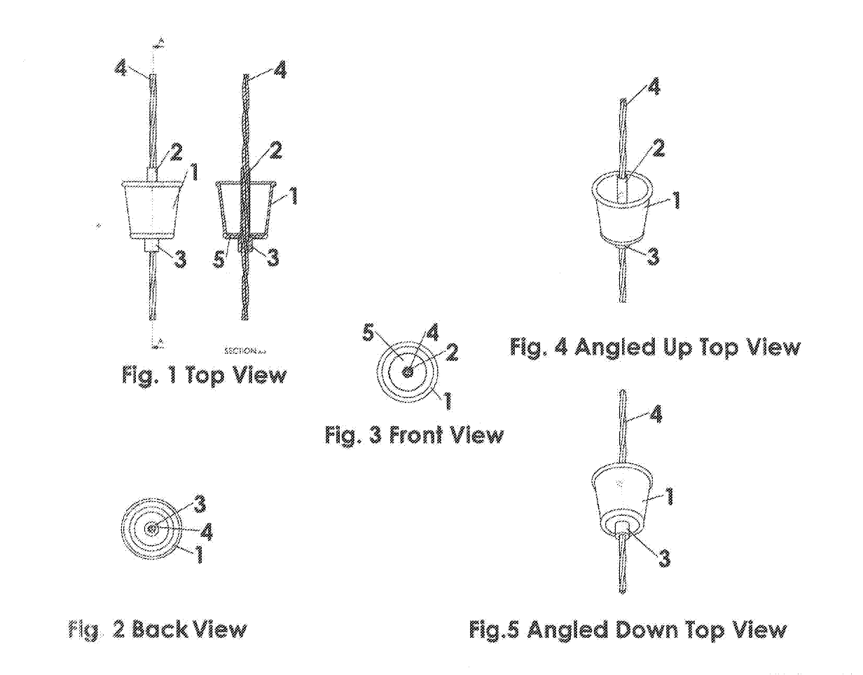

### DETAILED DESCRIPTION OF DRAWINGS

More accurately, the pest guard displayed in the drawings features a conical body (1) that can resemble a traditional flowerpot shape, such as the one displayed in the image. This shape is ideal for the application of a multi-pest prevention device. The open faced shape prohibits the passage of large pests such as vermin, rodents and lizards by eliminating any area that pest could grab ahold of and use to climb over the device. In addition, the diameter of the open face is large enough to ensure that such pests are unlikely to jump over the device from their position on the dock line. This shape is also unique in that, it may allow pests that were already onboard the vessel at the time of device application to crawl off. While this is not a primary function of the device, it serves as an added bonus, since any pest that would otherwise be trapped on the vessel with no means to sustain itself, will die and become a nuisance to clean up and remove from the vessel post mortem.

The conical body (1) is also designed to fully rotate around in all directions. This serves to prohibit larger pests such as raccoons that may be tall enough to climb over the open face of the device from having stable ground to grab ahold of. Once the animal tries to shift weight to the top of the conical section, the device will spin, causing the animal to lose its hold of the device. The conical shape of the pest guard is unique and important in more ways than one, however. This shape allows for the placement of a “glue trap” or “sticky tape” that prohibits crawling insects from gaining access to the vessel. The conical shape also serves to protect the “glue trap” from the elements of nature such as direct sunlight and rain, which would decrease the lifespan and usefulness of the tape. This tape is further described below.

The shaft displayed in the images (2) provides a stabilizing member for the conical body to stay centered on the dock line. Without this centering shaft, the conical body of the device would constantly rest on the line, and not provide the protection that the device is designed to provide. A pest guard without this shaft would easily be climbed by pests. Furthermore, the interior of this shaft may be padded with a flexible foam that would allow the device to fit securely on a dock line and even hold it in place on the line (not allow it to slide up and down of the line), but would still prohibit crawling pests such as insects from walking though, to the other side of the line.

The tightening collar shown in section (3) has a primary purpose of holding the main portions of the device together. This collar connects to the shaft of the device and may have a flexible foam that prohibits any crawling pests such as ants from crawling from one end of the rope to the other by going through the opening in the device that is meant for dock lines. This foam can also help to secure the device on the line and prohibit it from sliding up and down, along the line.

The rope displayed in the drawings (4) is for display purposes of how the device will look while installed on a dock line and is not an actual part of the pest guard. However, since dock lines are the integral reason for needing this device, it is important to characterize them and display how the device functions on the dock line. The line runs through the middle of the protector, allowing the guard to rest on the line.

Perhaps the most unique aspect of this invention's design is the section of the device that allows for the placement of “sticky tape” or other adhesive material. This sticky tape is displayed in part (5) and may consist of a simple piece of paper that has glue on both sides that will stick to the bottom of the interior wall of the conical shaped pest guard. This sticky material serves to prevent the passage of crawling insects that can no longer pass through to the vessel by way of the dock line, due to foam isolating one side of the dock line from the other inside the shaft or the tightening collar.

What is claimed:

1. A pest prevention shield to impede the passage of vermin, reptiles and insects along mooring lines which connect vessels to shore, comprising:
a rigid conical barrier of sufficient diameter to inhibit jumping of vermin and reptiles, which is positioned in the central portion of a rigid tube such that the tube will be slid onto a mooring line and the conical structure is allowed to rotate freely around the centerline, such that it will spin readily if weight is applied to it by vermin or other pests.

2. The shield of independent claim 1 wherein said shield is formed partially or in entirety from polyethylene, polypropylene, polyurethane, PVC, or other plastic materials.

3. The shield of independent claim 1 wherein said shield may be formed partially or in entirety from metals that provide the device with increased rigidity and strength in applications where such requirements are needed.

4. The shield of independent claim 1 wherein said shield is formed from material that has a mass density less than water so that the device may float in water.

5. The shield of independent claim 1 wherein said shield is coated in a coating that prevents the corrosion and deterioration of the device in a corrosive environment.

6. The shield of independent claim 1 wherein said shield may have a moving main body or moving appendages to further prevent the passage of vermin over the shield.

7. The shield of independent claim 1 wherein said shield may have an openable and re-closable slot running along the entire central axis of it, allowing for it to be easily placed on a mooring line without the mooring line being removed from the dock.

8. The shield of independent claim 1 further comprising of a platform inside said conical device, which is rigid and flat, so as to provide an appropriate surface for the installation of an insect and small lizard trap that is covered with a sticky surface material such that the trap is shielded from the elements and protected from decay by water and sunlight. This surface shall allow for convenient placement and easy replacement of said traps.

9. The shield of dependent claim 8 wherein said sticky trap is replicable and may be comprised of a flat circular disk with a slit, allowing it to be placed on the device without the removal of the shield from the line.

10. The shield of dependent claim 8 wherein in said trap is comprised of a non-toxic glue that is comprised of mineral oils, resins and synthetic rubber.

11. The shield of dependent claim 8 wherein said trap is comprised of an adhesive backing so that the sticky glue trap may be attached to the interior of the conical device.
